(19) United States
(12) Patent Application Publication
(10) Pub. No.: US 2026/0119642 A1
(43) Pub. Date: Apr. 30, 2026

(54) ATTESTED CONTENT CREATION BY INFORMATION HANDLING SYSTEMS

(71) Applicant: Dell Products L.P., Round Rock, TX (US)

(72) Inventors: Marcus Daniel Molner, Austin, TX (US); Walter Kemp, Georgetown, TX (US); Kai Wang, Shanghai (CN)

(73) Assignee: Dell Products L.P., Round Rock, TX (US)

(21) Appl. No.: 18/928,740

(22) Filed: Oct. 28, 2024

(51) Int. Cl. G06F 21/50; G06F 9/455; H04L 67/1396; H04W 4/02

(52) U.S. Cl. CPC G06F 21/50; G06F 9/455; H04L 67/1396; H04W 4/02

(57) ABSTRACT

Systems and methods are provided for attested content creation by an Information Handling System (IHS). A virtual environment is launched for attested content creation by a user of the IHS, with the environment providing applications for content creation using I/O devices of the IHS. Once the virtual environment has been launched, user inputs to the I/O devices are monitored and imports to the virtual environment are monitored. Entry of content to an application of the virtual environment is detected and an originality score is generated for the entered content, where the score is based on the detected user inputs to the I/O devices and on the monitored imports to the virtual environment. When the originality score indicates the entered content was human-generated, an attestation certificate is generated for validation of the entered content as human-generated.

### FIELD

This disclosure relates generally to Information Handling Systems (IHSs), and more specifically, to validating authorship of content created using IHSs.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

Personal IHSs, such as a laptop or desktop computer, are used in a wide array of different forms of content creation. For instance, users of an IHS may operate software programs on the IHS to draft documents and create images. Recently, artificial intelligence (AI) tools available via the Internet have allowed users to generate high-quality writings and images based on prompts and other information provided to the AI tools. With the proliferation and emerging sophistication of such AI tools, discerning whether content has been generated in whole or in part by such AI tools is increasingly difficult.

### SUMMARY

In various embodiments, systems and methods are provided for attested content creation by an Information Handling System (IHS). Embodiments may include: launching a virtual environment for attested content creation by a user of the IHS, the environment providing one or more applications for content creation using one or more I/O devices of the IHS; once the virtual environment has been launched, monitoring user inputs to the I/O devices of the IHS and monitoring imports to the virtual environment; detecting entry of content to an application of the virtual environment; generating an originality score for the entered content based on the detected user inputs to the I/O devices of the IHS and further based on the monitored imports to the virtual environment; and when the originality score indicates the entered content was human-generated, generating an attestation certificate for validation of the entered content as human-generated.

In some embodiments, the monitoring of imports to the virtual environment comprises monitoring activity of a clipboard of an operating system of the IHS. In some embodiments, the monitoring of imports to the virtual environment comprises monitoring file operations by the user of the IHS. Some embodiments may also include monitoring Internet activity by the user and further generating the originality score based on Internet activity by the user. Some embodiments may also include adjusting the originality score based on a source of the detected imports to the virtual environment, where the source is identified in the monitored Internet activity. In some embodiments, the monitoring of user inputs to the I/O devices of the IHS comprises monitoring at least one of keyboard entries and mouse inputs. In some embodiments, the originality score is generated in part based on detected user inputs to the I/O device relative to expected human inputs to the I/O devices in order to generate the entered content. Some embodiments may also include determining a type of attestation certificate to be generated based on the originality score relative to originality score thresholds for generating different types of supported attestation certificates. In some embodiments, a first type of attestation certificate validates the entered content is human-generated. In some embodiments, a second type of attestation certificate validates the entered content is generated by the user of the IHS. Some embodiments may also include once the virtual environment has been launched, monitoring a location of the user relative to the IHS. In some embodiments, the originality score is further generated based on a proximity of the monitored location of the user to the IHS. In some embodiments, the originality score is further generated based on a proximity of the monitored location of the user to a first of the user I/O devices used to enter the content.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS) configured, according to some embodiments, for attested content creation by the IHS.

FIG. 2A is a flowchart illustrating an example of a method, according to some embodiments, for attested content creation by an IHS.

FIG. 2B is a continuation of the flowchart of FIG. 2A.

FIG. 3 is a flowchart illustrating an example of a method, according to some embodiments, for attestation of presented content.

### DETAILED DESCRIPTION

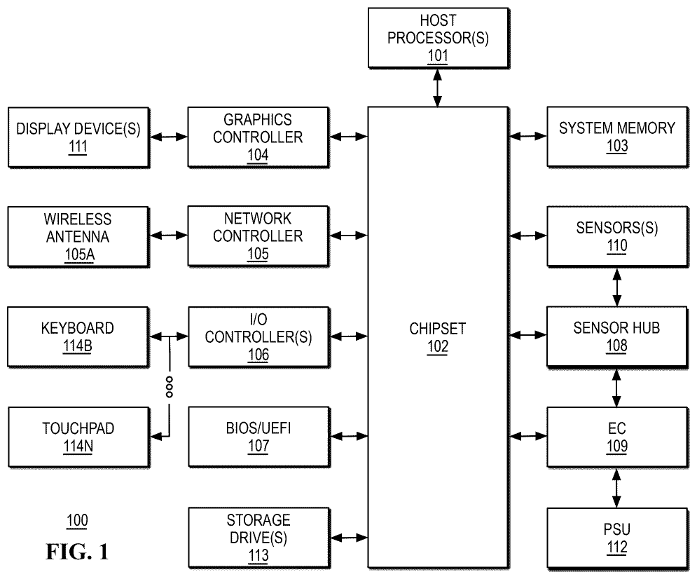

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail with regard to FIG. 1.

FIG. 1 is a diagram illustrating examples of components of an Information Handling System (IHS) 100 configured, according to some embodiments, to support attested content creation by the IHS. In some embodiments, IHS 100 may be a laptop computer or a desktop computer that may operate various software applications by which the user of the IHS may generate various forms of content. For instance, a user of IHS 100 may utilize a text editing application to generate a document and may use a graphics application to generate an image, where various combinations of text and image generation may also be supported by an application.

As described, the use of AI tools has allowed a user of an IHS to create works, such as text and images, that are comparable in quality to human-generated content. Users can invoke such AI tools to create content and may take credit for generating the content generated by the AI tool. Accordingly, in embodiments, an IHS 100 supports an attested content creation environment through which a user's generation of content is tracked and evaluated for indicators of originality and for indicators of the importing of AI-generated content. Though embodiments, an IHS 100 may support a virtual environment though which users generate content that may be rated based on the indications of the content being human generated and also based on the lack of indications of use of AI tools, where embodiments generate a cryptographic certificate for use in validating that the content that was created in the virtual environment is human generated, or generated by a specific registered user of the IHS.

As illustrated, IHS 100 includes host processor(s) 101. In various embodiments, IHS 100 may be a single-processor system, a multi-processor system including two or more processors and/or processor cores. Host processor(s) 101 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.). IHS 100 utilizes a chipset 102 that may include one or more integrated circuits that are connected to processor 101. In the embodiment of FIG. 1, processor 101 is depicted as separate component from chipset 102. In other embodiments, all of chipset 102, or portions of chipset 102 may be implemented directly within the integrated circuitry of the processor 101. Chipset 102 provides the processor(s) 101 with access to a variety of resources of the IHS.

In some embodiments, processor 101 may include an integrated memory controller that may be implemented directly within the circuitry of the processor 101, or the memory controller may be a separate integrated circuit that is located on the same die as the processor 101. The memory controller may be configured to manage the transfer of data to and from the system memory 103 of the IHS 100 via a high-speed memory interface. The system memory 103 provides the processor 101 with a high-speed memory that may be used in the execution of computer program instructions by the processor 101. Accordingly, system memory 103 may include memory components, such as such as static RAM (SRAM), dynamic RAM (DRAM), NAND Flash memory, suitable for supporting high-speed memory operations by the processor 101. In certain embodiments, system memory 103 may combine both persistent, non-volatile memory and volatile memory. In certain embodiments, the system memory 103 may be comprised of multiple removable memory modules.

As illustrated, a variety of resources may be coupled to the processor(s) 101 of the IHS 100 through the chipset 102. For instance, chipset 102 may be coupled to a wireless network controller 105 that may support different types of wireless network connectivity. In certain embodiments, wireless network controller 105 may include one or more Network Interface Controllers (NICs). In some embodiments, wireless network controller 105 may implement hardware for communicating via a specific networking technology, such as Wi-Fi, BLUETOOTH, and mobile cellular networks (e.g., CDMA, TDMA, LTE). In some embodiments, network controller 105 may support wireless Wi-Fi communications, and my include a Wi-Fi controller or wireless NIC card by which IHS 100 transmits and receives wireless Wi-Fi signals.

In some embodiments, the wireless signaling utilized by wireless network controller 105 may be implemented using multiple wireless antenna 105a. In transmitting and receiving wireless signals using multiple antenna 105a, the strength of signals that are received by each of these antenna 105a may be analyzed to provide directional information regarding the environment in which the wireless signals are propagated. In some embodiments, the directional information that is used in the transmission and reception of wireless signals from each of the antenna 105a may be used to detect the presence of the user of the IHS 100 relative to the position of the IHS itself. As described in additional detail below, in some embodiments, such user presence detection information may be utilized in evaluating the likelihood of a user manually generating a particular portion of content, where this likelihood information may then be used in making an evaluation as to whether to generate a certificate for validation of the content as human-generated.

Returning to the hardware and software of an IHS according to embodiments, chipset 102 also provides processor 101 with access to one or more storage drives 113. In various embodiments, storage drives 113 may be integral to the IHS, or may be external to the IHS 100. In some embodiments, storage drive(s) 113 may be accessed via a storage controller that may be an integrated component of the storage device. In some embodiments, a storage controller may be a system-on-chip function of processor(s) 101. Storage drive(s) 113 may be implemented using any memory technology allowing IHS 100 to store and retrieve data. For instance, storage drive(s) 113 may be a magnetic hard disk storage drive or a solid-state storage drive. In certain embodiments, storage drive(s) 113 may include a system of storage devices, such as a cloud drive accessible via network interface 105.

As illustrated, IHS 100 also includes a BIOS (Basic Input/Output System) 107 that may be stored in a non-volatile memory accessible by chipset 102. In some embodiments, BIOS 107 may be implemented using a dedicated microcontroller coupled to the motherboard of IHS 100. In some embodiments, BIOS 107 may be implemented as operations of embedded controller 109. Upon powering or restarting IHS 100, processor(s) 101 may utilize BIOS 107 instructions to initialize and test hardware components coupled to the IHS 100. The BIOS 107 instructions may also load an operating system for use by the IHS 100. The BIOS 107 provides an abstraction layer that allows the operating system to interface with certain hardware components of the IHS 100. The Unified Extensible Firmware Interface (UEFI) was designed as a successor to BIOS. As a result, many IHSs utilize UEFI in addition to or instead of a BIOS. As used herein, BIOS is intended to also encompass UEFI.

As described, one or more display devices 111 may be coupled to IHS 100. Display device(s) 111 may include a plurality of pixels that are arranged in a matrix and are configured to display visual information. Display device(s) 111 may include Liquid Crystal Display (LCD), Light Emitting Diode (LED), organic LED (OLED), or other thin film display technologies. IHS 100 may support an integrated display device, such as a display integrated into a laptop, tablet, 2-in-1 convertible device, or mobile device. In some embodiments, IHS 100 may be a hybrid laptop computer that includes dual integrated displays incorporated in both of the laptop panels. IHS 100 may also support use of one or more external displays, such as external monitors that may be coupled to IHS 100 via various types of couplings. External displays that are supported by IHS 100 may also include a projection display. The external displays of an IHS 100 may also include wearable displays, such as displays integrated within VR headsets.

In some embodiments, one or more of the display devices 111 may be capable of receiving touch inputs from a user. In some embodiments, these touch inputs received via display devices 111 may be processed by a touch controller that may be separate from other controllers used the display of content. In some embodiments, the touch controller functions may be implemented by a display controller. In some embodiments, touch controller may be an embedded component of an individual display device 111, such that IHS 100 may support multiple distinct touch controllers, each processing inputs from a separate display device 111, such as integrated touch controllers processing inputs from separate display panels of a laptop IHS. In all such implementations, embodiments may instrument the touch controller in order to track user inputs and other activity during use of an attestable content creation environment that is operating on the IHS.

In some embodiments, chipset 102 may operate the one or more display device(s) 111 via a graphics processor and/or GPU (Graphics Processor Unit) 104. In certain embodiments, a graphics processor 104 may be comprised within a video or graphics card or within an embedded controller installed within IHS 100. In certain embodiments, a graphics processor 104 may be integrated within processor 101, such as a component of a system-on-chip.

Chipset 102 may also provide access to one or more user input devices, in some instances using one or more I/O controller(s) 106 or the like. Examples of user input devices include, but are not limited to a touchpad (such as a touchpad integrated in the palm rest area of a laptop IHS), keyboard 114B and mouse 114C. In some embodiments, a single controller may support multiple of these user input devices, such as a keyboard controller that detects inputs from the keyboard 114B and also detects inputs from a touchpad 114 integrated in the palm rest, and also detects mouse 114C inputs detected by buttons included on or under a palm rest of an laptop IHS 100. In some embodiments, other user input devices supported through the operation of I/O controller(s) 106 may include a stylus, microphone(s) and camera(s) that may each be integrated or external components of an IHS 100. In some embodiments, embodiments may instrument such I/O controllers in order to track user inputs and other activity during use of an attestable content creation environment that is operating on the IHS.

Some IHS 100 embodiments may utilize an embedded controller 109 that may be a motherboard component of IHS 100 and may include one or more logic units. In certain embodiments, embedded controller 109 may operate from a separate power plane from the main processors 101 of IHS, and thus from the operating system functions of IHS 100. In some embodiments, firmware instructions utilized by embedded controller 109 may be used to operate a secure execution environment that may include operations for providing various core functions of IHS 100, such as power management and management of certain operating modes of IHS.

For instance, embedded controller 109 may implement operations for interfacing with a power supply unit (PSU) 112 in managing power for IHS 100. In certain instances, the operations of embedded controller may determine the power status of IHS 100, such as whether IHS 100 is operating strictly from battery power, whether any charging inputs are being received by power supply unit 112, and/or the appropriate mode for charging the one or more battery cells of the IHS using the available charging inputs. Embedded controller 109 may support routing and use of power inputs received via a USB port and/or via a power port supported by the power supply unit 112. In addition, operations of embedded controller 109 may interoperate with power supply unit 112 in order to provide battery status information, such as the state of charge of the battery.

In some embodiments, embedded controller 109 may also implement operations for detecting certain changes to the physical configuration of IHS 100 and managing the modes corresponding to different physical configurations of IHS 100. For instance, where IHS 100 is a laptop computer or a convertible laptop computer, embedded controller 109 may receive inputs from a lid position sensor that may detect whether the two sides of the laptop have been latched together, such that the IHS is in a closed position. In response to lid position sensor detecting latching of the lid of IHS 100, embedded controller 109 may initiate operations for shutting down IHS 100 or placing IHS in a low-power mode. In this manner, IHS 100 may support the use of various power modes.

In managing the operation of IHS 100 according to its physical posture, embedded controller 109 may identify any number of IHS physical postures, including, but not limited to: laptop, stand, tablet, or book postures. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user. In some embodiments, the physical posture of a convertible IHS may be utilized as a factor in evaluating the likelihood of a user manually generating a particular portion of content, where this likelihood information may then be used in making an evaluation of whether to generate a certificate for validation of the content as human-generated.

IHS 100 may include a wide variety of sensors 110 for use in gathering telemetry data that can be used in the management of operations by the IHS, and in embodiments, for describing the context of the IHS's 100 current operations, where this context information may be used in the selection and/or adjustments of the color definitions to be used for the display of content. Sensors 110 may be disposed on or within the chassis of IHS 100, or otherwise coupled to IHS 100, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s). Sensors 110 may include geo-location sensors capable for providing a geographic location for IHS 100, such as a GPS sensor or other location sensors configured to determine the location of IHS 100 based on triangulation and network information. Various sensors, such as optical, infrared and sonar sensors, may be used in the detection of individuals in proximity to the IHS 100 and/or in other forms of user presence detection. In some embodiments, user presence detection may be provided using a combination of sensor 110 information and using wireless signal information and collected by network controller 105.

Whereas some embodiments may support attestation that content was human-generated and not generated using AI tools, some embodiments may additionally or alternatively support attestation that a specific individual created the content, and did not utilize AI tools in doing so. In such embodiments, an IHS 100 may utilize its user presence detection capabilities to identify individuals other than a registered user in close proximity to the IHS and/or to specific user input devices of the IHS, such as a detected individual's proximity to a wireless keyboard of the IHS relative to the location of the user of the IHS. In this manner, embodiments may support multiple different forms of attestation for content generated using the IHS, with different forms of supported attestation providing different levels of certainty with regard to the individual that generated content, and/or with regard to the certainty that AI tools were not used in generating the content.

In some embodiments, sensor hub 108 may utilize data from inertial movement sensors, that may include accelerometer, gyroscope, and magnetometer sensors, to determine the current orientation and any movement of IHS 100 (e.g., IHS 100 is motionless on a relatively flat surface, IHS 100 is being moved irregularly and is likely in transport, the hinge of IHS 100 is oriented in a vertical direction). In certain embodiments, the sensor hub 108 may also include capabilities for determining a location and movement of IHS 100 based on triangulation of network signal and based on network information provided by the OS or by a network interface.

In some embodiments, an IHS 100 may not include all of the components shown in FIG. 1. In other embodiments, an IHS 100 may include other components in addition to those that are shown in FIG. 1. Furthermore, some components that are represented as separate components in FIG. 1 may instead be integrated with other components. For example, in certain embodiments, all or a portion of the operations executed by the illustrated components may instead be provided by components integrated into processor(s) 101 as systems-on-a-chip.

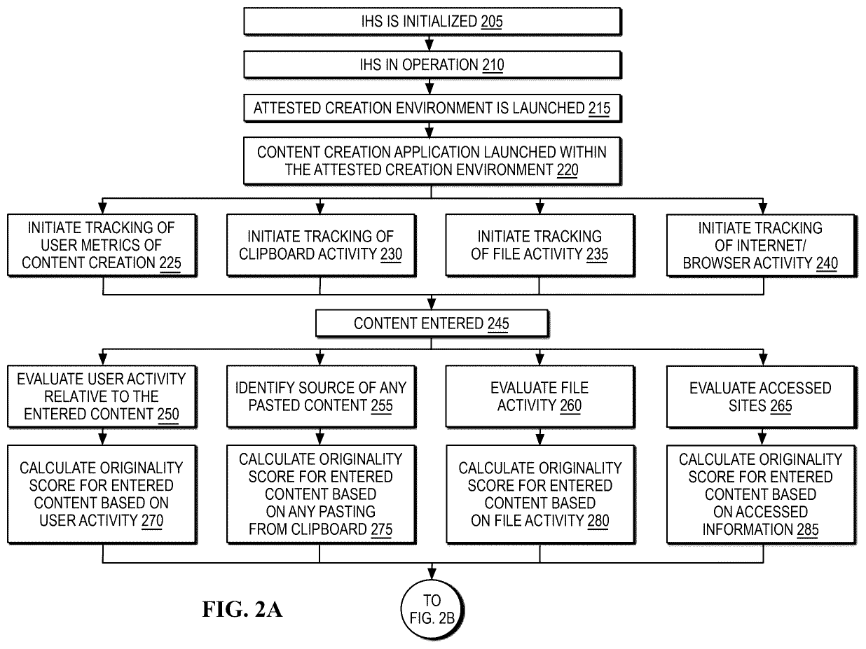

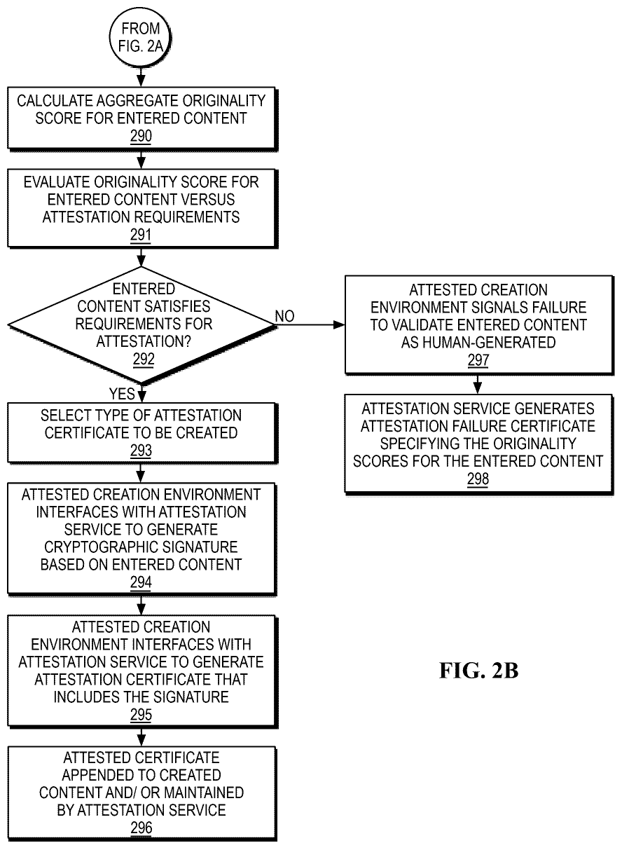

FIG. 2A is a flowchart illustrating an example of a method, according to some embodiments, for attested content creation by an IHS 100. Embodiments may begin, at 205, with the initialization of an IHS 100, such as upon booting or restarting the IHS. In some embodiments, upon initialization of an IHS, instructions to be loaded for use by hardware components of the IHS, such as firmware and other settings, may be validated as authentic based on comparisons of the instructions to be loaded against reference signatures corresponding to authentic instructions. Upon successful validation of such instructions, one or more of the hardware components of the IHS 100 may load validated instructions and may thus operate based on execution of these trusted instructions.

In some embodiments, this validated firmware to be loaded by components of the IHS 100 may include firmware for use in operating aspects of an attested content creation virtual environment. As described above, some embodiments may evaluate the likelihood of a human user generating content based on contextual indicators, such as user presence detection capabilities that may be implemented based on validated firmware operations of a network controller 105, embedded controller 109 and/or sensor hub 108. In some embodiments, such validated firmware instructions may be adapted to interoperate with a virtual environment that runs on IHS 100 and that includes applications for attested content creation.

Once firmware instructions have been validated, further initialization may include initiating the IHS 100 boot sequence and loading operating system instructions. Once a requisite amount of instructions have been loaded, the IHS may boot an operating system and, at 210, the IHS may be operated by the user. The IHS may be operated for any amount of time by the user until, at 215, a virtual environment for attested content creation is launched. In some instances, the virtual environment may be launched in response to the user manually initiating the virtual environment. In some instances, the virtual environment may be launched automatically, such as upon booting of the operating system, or such as upon the user selecting a filetype that has been designated for operation by the virtual environment, or for operation by an application that operates within the virtual environment.

In some embodiments, the attested content creation environment may be operated in part by an embedded controller 109 of the IHS, where the embedded controller may interface with the operating system of the IHS and also with sensor hub 108 in collecting and evaluating indicators of the user's activity relative to the content that is created in the attested creation environment. For instance, the embedded controller 109 may interface with the sensor hub 108 in collecting and evaluating context information, such as user presence detection determinations, that may provide indications that content that is being generated using the attested creation environment may have been authored by an individual other than the user of the IHS.

In some embodiments, the attested content creation environment may be a virtual environment that operates in a segregated logical environment of the IHS. In some embodiments, the attested content creation environment may operate as a virtual machine, workspace or the like, that operates using segregated portions of the IHS file system, and in some embodiments using segregated portions of system memory 103. In some embodiments, the attested content creation environment may be virtual environment that operates using an encrypted file system and using segregated, encrypted portions of system memory 103, thus logically isolating the attested content creation environment from other applications operating in the operating system, or elsewhere, on the IHS.

The attested content creation environment may support a variety of content creation applications that, at 220, may be launched, such as through manual user operation of user interfaces supported by the environment. The content creation applications supported by the attested content creation environment may include a variety of applications used for generating and/or editing various combinations of text, images, audio, etc. Once such an application has been initiated within the attested content creation environment, embodiments may initiate various forms of tracking used to determine whether content entered into the application is being generated by a human user of the IHS 100, and to confirm that the content has not been generated in full or in part using AI content creation tools, such as described above. In some embodiments, such tracking may be initiated as soon as the attested content creation environment has been launched, or as soon as the IHS 100 has been booted.

As indicated in FIG. 2A, the monitoring that is initiated in some embodiments may include tracking various metrics of content creation by a user of the IHS 100. Such tracking may include various forms of tracking user activity that indicates whether the user is generating the content that is entered in the application, such as tracking user inputs to the I/O devices of the IHS, and such as tracking the physical presence of the user, and of other individuals, relative to the location of the IHS. In some embodiments, such user tracking may be implemented at least in part by the embedded controller 109, which may interface with the sensor hub 108 in collecting and evaluating information that provides indications of the user's physical location relative to the IHS, and in detecting the presence of individuals other than the user of the IHS in close proximity to the IHS, or to I/O devices being used to enter content to the attested content creation environment application, such as a wireless keyboard.

As described above, in some embodiments, embedded controller 109 may interface with I/O controllers 106 of the IHS in tracking key stroke information, mouse inputs and/or touch pad inputs. Through tracking of such information, in particular during intervals when content is being entered to an application, embodiments provide indications whether the entered content is actually being generated by a user of the IHS, or has been generated by an AI tool, or by another outside source other than the user of the IHS. For instance, through tracking of keystroke frequency and patterns, embodiments may discern that the user may be transcribing text that is being displayed by another user interface, such as a browser window, or by another IHS or other device.

While operating as a background process, user activity monitoring by embodiments may monitor inputs to I/O devices of the IHS, such as tracking the frequency and other timing characteristics of keyboard, mouse and/or touchscreen inputs. Through monitoring of such inputs, embodiments may generate a profile of inputs by the user of the IHS over time, with the profile being used to identify periods during the content creation where the detected inputs deviate from the user's profile, thus indicating the user is transcribing content, rather than genuinely creating the content that is being entered.

As indicated in FIG. 2A, at 230, the monitoring that is initiated in some embodiments may include tracking of clipboard activity that is supported by the IHS 100, such as by the operating system of the IHS. Through clipboard operations, a user may transfer content between different applications operating on an IHS, or between two different instances of an application operating on an IHS. Accordingly, a user that is copying content generated by an AI tool or by another source may utilize such clipboard functions to insert the copied content to the attested content creation environment.

Some embodiments may additionally initiate, at 235, tracking of file operations of the IHS 100, in particular user file operations that may be used to open files that may include content that could be transcribed or otherwise copied by the user into the application of the attested content creation environment that is being used to enter content. In addition, at 240, some embodiments may initiate tracking of Internet activity by the user, such as tracking of URLs that are accessed by the user of the IHS using web browsers operating on the IHS. As described in additional detail, this tracking of Internet traffic may be used in determining the source for content that has been pasted or otherwise imported into the attested content creation environment.

Monitoring may continue for any amount of time when, at 245, the user begins entry of content to an application of the attested content creation environment. In some scenarios, a user may begin entry of content through keyboard entry of text or from speech recognition generated text. In other scenarios, a user may begin entry of content though use of digital illustration tools, such as to generate an image, using mouse, touch and/or keyboard inputs. Depending on the application of the attested content creation environment being used, various combinations of text and image creation may be supported. In some scenarios, entry of content may include importing of previously generated content. As described in additional detail below, importing of content may or may not indicate the content is human generated.

Entry of content may continue for any amount of time when the entered content is evaluated for originality, and in particular for indications of original creation of the content by the user of the IHS. Based on the outcome of this evaluation, a digital certificate may be generated for the entered content, whereby the certificate attests to the content being human generated. Some embodiments may defer any evaluation of originality of entered content until the entry of content has been completed, such as based on express confirmation by the user (e.g., a user selecting an option to submit the entered content). Some embodiments may initiate an evaluation of originality in response to termination of the application and/or attested content creation environment. Some embodiments may initiate an evaluation of originality after a pre-defined time interval has elapsed.

As indicated, at 250, the evaluation of the entered content for originality may begin with the evaluation of user activity relative to the entry of the content. As described, monitoring of I/O inputs by the user may include monitoring of user input devices used to enter the content, such as monitoring keyboard activity and mouse or other pointing device activity. Based on such activity, embodiments may identify incongruities between the I/O device inputs and the entered content that may indicate the entered content was not created by the user of the IHS. For instance, patterns of regular typing with only minimal corrections or revisions (e.g., use of backspace or delete keys) may indicate that entered text is being transcribed from another source rather than being original authorship. In another scenario, embodiments may indicate a lack of originality based on the entered content being imported, such as through paste operations, without any further revisions of the imported content. In another scenario, embodiments may indicate a lack of originality based on the repeated entry and deletion of text that is never actually included in the final entered content, thus indicating the entry of text as subterfuge, such as to give the appearance of original authorship.

As described above, the monitoring of user activity relative to the entered content may also include evaluation of the user's physical presence relative to the IHS. For instance, indications that the user did not enter inputs beyond importing content and was not even in proximity to the IHS provides an indication the user did not spend any time reviewing or revising the entered content. In scenarios where embodiments detect the presence of multiple individuals in proximity to the IHS, the source of the entered content may be in question, thus indicating the entered content was not authored by a registered user of the IHS.

In some embodiments, the sensor hub 108 of the IHS may include capabilities for biometric identification of specific individuals, such as based on facial recognition. In such instance, user presence detection capabilities of IHS 100 may be used in embodiments to determine when individuals other than a specific individual, such as a registered user of the attested content creation environment and/or IHS. The likelihood that the entered content was authored by an individual other than the registered user of the IHS increases based on the other individual being detected in closer proximity to the IHS than the user. Similarly, this likelihood may also be increased through the detection of an individual other than the registered user of the IHS in close proximity to the I/O device being used to enter the content, such as an integrated or external keyboard. In this manner, a variety of user actions may be monitored and evaluated, and in particular monitored for indications of actual authorship during intervals where the content is being actively entered.

Based on monitored user activity in conjunction with the entry of the content, at 270, embodiments may generate an originality score reflecting the confidence that the user of the IHS generated the entered content and is the original author of the content. For instance, a numerical scale may be used where the top value indicates maximum confidence the entered content was generated by the registered user of the IHS and the lowest value indicating the registered user of the IHS conclusively did not generate the entered content. Intermediate values indicate varying degrees of confidence that the entered content is all a product of original authorship by a human user of the IHS.

As indicated in FIG. 2A, at 255, evaluation of the entered content may also include evaluation of content pasted during the interval of content entry. In scenarios where content was pasted from a clipboard to an application of the attested content creation environment, embodiments may seek to identify the source of the pasted content. In some instance, the pasted content may include metadata, a watermark or other identifier that specifies the creator of the content. In such instances, embodiments may collect URLs or any personal or organizational identifiers that are included in the pasted content itself, in metadata associated with the pasted content and/or available through features of the clipboard function used to paste content.

In some scenarios, pasting of content does not indicate a lack of human originality. The use of stock images or licensed images that are identified as such in the entered content indicates that this portion of the entered content is not claimed as being authored by the user. Similarly, a user may paste text into a document for use of that text verbatim as quoted or cited information, with other portions of the entered content presumably providing original authorship in reference to the pasted text. Embodiments may account for a variety of such scenarios in calculating, at 275, an originality score may be calculated to reflect the confidence that the clipboard activity detected during entry of content is consistent with a work of original authorship. As above, a numerical scale may be used where the top value indicates maximum confidence the entered content is an work of original authorship and the lowest value indicating the entered content is copied entirely from an external source, such as an AI tool.

Although use of a clipboard function may be a legitimate operation in an original work, this function provides many opportunities for importing content generated by others, such as through plagiarism or use of AI tools, and misrepresenting the content as a human generated work by a user of the IHS. Accordingly, embodiments may evaluate all pasted content for indications it has been generated by an AI tool. Some AI tools may assist in such operations through uses of watermarks or other encoded information. As described, embodiments may also track Internet activity by the IHS. Embodiments may thus cross-reference tracked Internet activity with the use of the pasted content in order to ascertain possible sources of the pasted content. Embodiments may thus generate an originality score, at 275, that reflects the degree to which pasted content can be ascertained as not importing AI-generated content, or content created by another source.

As indicated in FIG. 2A, at 260, evaluation of the entered content may also include evaluation of file activity during the interval of content entry. In scenarios where the user accessed any files during the entry of content, embodiments may evaluate those file operations for any indications that content from a file is being imported into the attested content creation environment and misrepresented as an original work of the user of the IHS 100. As with clipboard activity, not all file activity indicates misrepresentation.

For instance, a user may be resuming prior work, in which case embodiments may support additive attestation, such that a user may import a file that includes a previously generated attestation certificate for use in validating that the content in the file is human-generated, or generated by a specific individual. In such embodiments, the originality score(s) included in this prior attestation certificate may be used as starting originality score(s) for further editing of the file. In another scenario, a user may open a file for review of information as part of a work of original authorship, such as opening an file to view an image that is then described in a text description by the user as an original work of authorship. Embodiments may account for a variety of such scenarios in calculating, at 280, an originality score to reflect the confidence that the file activity detected during entry of content is consistent with a work of original authorship.

As indicated in FIG. 2A, at 265, evaluation of the entered content may also include evaluation of the user's Internet activity during the interval of content entry. In scenarios where the user accessed any information via a web browser or other Internet-connected application, embodiments may evaluate the monitored Internet activity for any indications that AI tools are being accessed. As described, content generated from AI tools may be pasted into an application and misrepresented as a work of original authorship by a user of the IHS. Unlike file activity or use of a clipboard function where not all actions indicate attempts to misrepresent authorship, any Internet activity that accesses an AI tool, or seeks to obfuscate possible access to an AI tools (e.g., use of VPN or anonymization service), may indicate a lack of original authorship of the entered content. As described, the monitored Internet activity may be used in cross-referencing other user activity, such as to determine the source of pasted content. Independent from such cross-referencing, at 285, an originality score may be calculated to reflect the confidence that the Internet activity is consistent with a work of original authorship.

With one or more originality scores based on activity information that was collected during the entry of content, as indicated in FIG. 2A, at 290, these originality sub-scores may be aggregated to generate a comprehensive score for determining whether the entered content can be assured as being human-generated, or generated by a specific individual. Embodiments may combine available originality sub-scores in a variety of manners. For instance, embodiments may normalize any differences used in the sub-scores and may generate an aggregate score that may be an average or other combination of the originality sub-scores. Some embodiments may generate an aggregate score that is a weighted average of the originality sub-scores, with the different sub-scores weighted based on the amount of activity from which the sub-score was generated. For instance, an originality sub-score for the clipboard activity may be weighted low if the clipboard was used only once to paste a relatively small amount of text, while this sub-score may be weighted much greater in generating the aggregate score when a large amount of clipboard activity was detected and the pasting included relatively large portions of text.

In some embodiments, the aggregate score may be adjusted to reflect cross-referenced activity that is represented in more than one of the originality sub-scores. For instance, the monitoring of clipboard activity may include evaluation of Internet activity in order to determine the source of a content pasted from the clipboard. In such instances, embodiments may adjust the aggregate score, or adjust the weights for the involved originality sub-scores, to reflect the indications of use of imported material as being supported by activity from multiple monitored sources, thus increasing the confidence in asserting the entered content is not a work of original authorship.

In another illustrative cross-referencing scenario, embodiments may adjust the aggregate score based on evaluation of any editing of pasted content. Monitoring of clipboard activity may detect content being copied from a web site and pasted to the application of the attested content creation environment, where the amount and source material copied to the clipboard reflected in the originality sub-score for clipboard activity. Embodiments may also cross-reference the pasted content with monitored user I/O device activity that indicates editing of the pasted content, or that indicates that lack of any editing of this content.

In evaluating cross-referenced activity, embodiments may distinguish between content that is copied verbatim from the clipboard and properly attributed or otherwise sourced (e.g., though a footnote, endnote, citation, etc.) and content that is copied from the clipboard and altered to varying degrees and included in this manner in the entered content. In the former scenario, the aggregate score may be adjusted upwards to reflect the confidence that the clipboard activity is a source of a legitimate attributable citation, or may be adjusted downwards to reflect the confidence that the clipboard activity represents a misrepresentation of content that was not generated by the user of the IHS.

As indicated in FIG. 2B, embodiments may continue, at 291, through evaluation of the aggregate originality score that was generated for the entered content. In particular, the aggregate originality score is evaluated versus one or more thresholds for attestation of the entered content as human-generated, or as generated by a specific individual. Various other thresholds may be used for different attestation requirements, such as attestation that the entered content was generated without any importing of content from any sources and/or without IHS 100 Internet activity, or at least without certain types of Internet activity such as use of a web browser. Also, as described above, embodiments may provide assurances that the entered content was entered by a registered individual, with additional assurances possible with regard to possible input from other individuals being used in the creation of entered content (i.e., assurances that the entered content was generated without any substantial in-person interaction with other nearby individuals).

Based on the available forms of attestation that are being supported, at 292, embodiments determine whether the aggregate originality score for the entered content satisfies the requirements for any of the supported attestations. In scenarios where the aggregate originality score does not satisfy the requirements for any of the supported attestations, the entered content is deemed as not human-generated, or at least substantially human-generated such that little original authorship is present. For instance, evaluation of the clipboard and Internet activity may indicate the entered content that was substantially copied and pasted from an imported source, such as an AI tool, and included in the entered content with little or no editing by the user. Similarly, evaluation of imported content may indicate that portions of the entered content have been included verbatim, or nearly verbatim, without attribution in the entered content, thus indicating possible plagiarism.

In scenarios where the aggregate originality score of the entered content does not quality for any supported attestation, at 298, embodiments may generate an attestation failure certificate that can be used in resuming work on the entered content, with the originality score of the entered content established. In the same manner as an attestation certificate created for content that satisfies attestation requirements, the aggregate originality score may be cryptographically signed and included in the attestation failure certificate. In some embodiments, the originality sub-scores and/or logs describing monitored activity used in generating the sub-scores may also be signed and included attestation failure certificate. In a resumed attested content creation environment session, the user may resume work on the entered content that has been attested in the attestation failure certificate, with the beginning originality score for this new session being the signed originality score from the certificate. In this manner, a user may resume work on entered content and may retain previously earned originality as reflected in the originality score that is included in the attestation failure certificate.

In scenarios where the aggregate originality score of the entered content qualifies for one or more attestations, at 293, embodiments select from the supported attestations. Some embodiments may rank the available attestations that are supported based on the relative confidence that each attestation provides. In an illustrative embodiment, the highest rated attestation may affirm that a specific individual is the original human author of the entered content, without any substantial in-person human interaction with nearby individuals. A lower rated attestation may affirm only that a human operator of the IHS is the original human author of the entered content. A lowest rated attestation may affirm only that a human operator of the IHS entered the content and at least a certain percentage of the entered content appears to be human-generated. Embodiments may select the highest ranked of the attestations for which the entered content has qualified based on its aggregate originality score, or may select from the available attestations based on applicable policies.

In some embodiments, creation of the one or more attestation certificates proceeds, at 294, with the attested content creation environment interoperating with a remote attestation service for creation of the attestation certificate. In some embodiments, the entered content that has been validated as qualifying for attestation may be provided to the attestation service, along with the aggregate originality score, and in some instances along with the originality sub-scores and/or logs describing monitored activity used in generating the sub-scores. The attestation service may use the entered content to generate a digital signature, such as using hash operations, where the digital signature that is then cryptographically signed by the attestation service.

With the digital signature created and signed, it may be included, at 295, in an attestation certificate that is a cryptographic identity certificate that is generated by the attestation service, or on behalf of the attestation service by a trusted certificate authority. In some embodiments, a copy of the generated attestation certificate may be retained by the attestation service. In some embodiments, the generated attestation certificate may be transmitted to the attested content creation environment, where it may be appended to the entered content for use in future validation of the content as human-generated.

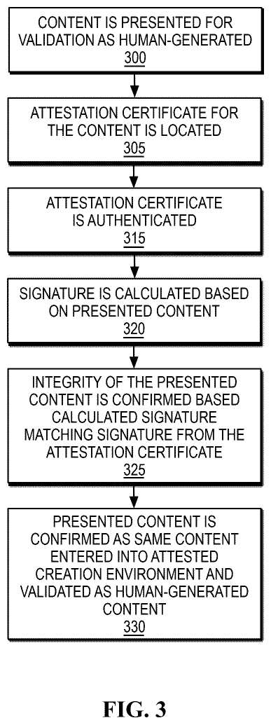

FIG. 3 is a flowchart illustrating an example of a method, according to some embodiments, for attestation of presented content. Embodiments may begin, at 300, with the presentation of content for validation as human-generated, such as in support of an individual submitting a scholarly assignment for grading, or an individual submitting an application. At 305, an attestation certificate for the presented content is located. As indicated, at 296 of FIG. 2, the attestation certificate that is created for attestation of human-generated content may be append to the content and/or centrally maintained. In some embodiments, the attestation certificate may be appended directly to the entered content, such as in the form of metadata or in the form of a link by which the attestation certificate can be retrieved. In some embodiments, the attestation certificate may be retrieved from the attestation service, or a datastore that operates in support of the attestation service. In some embodiments, a digital signature may be calculated based on the presented content and used to match the digital signatures include in attestation certificates maintained by such a attestation service datastore.

Once the attestation certificate has been located, at 315, the certificate may be authenticated such as through public key challenges to the certification authority that issued the certificate. If the certificate is authenticated, at 320, embodiments may calculate a digital signature for the presented content and may compare it versus the signed digital signature that is included in the attestation certificate in order to ensure the presented content is the same content for which the attestation certificate was generated, thus confirming, at 325, the integrity of the presented content as the same content that was attested using the attested content creation environment.

Based on confirmation of the integrity of the presented content, at 330, embodiments may confirm that the presented content was generated using the attested content creation environment and that the presented content has been affirmed as meeting the requirements for the specific attestation certificate that has been used to validate the presented content. For instance, based on the specific attestation certificate associated with the presented content, embodiments may confirm the presented content was entered into the attested content creation environment by a specific registered individual, or may confirm the presented content is not substantially created by AI tools or by other sources.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination of thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A method for attested content creation by an Information Handling System (IHS), the method comprising:
launching a virtual environment for attested content creation by a user of the IHS, the environment providing one or more applications for content creation using one or more I/O devices of the IHS;
once the virtual environment has been launched, monitoring user inputs to the I/O devices of the IHS and monitoring imports to the virtual environment;
detecting entry of content to an application of the virtual environment;
generating an originality score for the entered content based on the detected user inputs to the I/O devices of the IHS and further based on the monitored imports to the virtual environment; and
when the originality score indicates the entered content was human-generated, generating an attestation certificate for validation of the entered content as human-generated.

2. The method of claim 1, wherein the monitoring of imports to the virtual environment comprises monitoring activity of a clipboard of an operating system of the IHS.

3. The method of claim 1, wherein the monitoring of imports to the virtual environment comprises monitoring file operations by the user of the IHS.

4. The method of claim 1, further comprising monitoring Internet activity by the user and further generating the originality score based on Internet activity by the user.

5. The method of claim 4, further comprising adjusting the originality score based on a source of the detected imports to the virtual environment, where the source is identified in the monitored Internet activity.

6. The method of claim 1, wherein the monitoring of user inputs to the I/O devices of the IHS comprises monitoring at least one of keyboard entries and mouse inputs.

7. The method of claim 1, wherein the originality score is generated in part based on detected user inputs to the I/O device relative to expected human inputs to the I/O devices in order to generate the entered content.

8. The method of claim 1, further comprising determining a type of attestation certificate to be generated based on the originality score relative to originality score thresholds for generating different types of supported attestation certificates.

9. The method of claim 8, wherein a first type of attestation certificate validates the entered content is human-generated.

10. The method of claim 8, wherein a second type of attestation certificate validates the entered content is generated by the user of the IHS.

11. The method of claim 10, further comprising, once the virtual environment has been launched, monitoring a location of the user relative to the IHS.

12. The method of claim 11, wherein the originality score is further generated based on a proximity of the monitored location of the user to the IHS.

13. The method of claim 12, wherein the originality score is further generated based on a proximity of the monitored location of the user to a first of the user I/O devices used to enter the content.

14. An Information Handling System (IHS) comprising:
one or more processors; and
one or more memory devices coupled to the one or more processors, the memory devices storing computer-readable instructions that, upon execution by the one or more processors, cause the IHS to:
launch a virtual environment for attested content creation by a user of the IHS, the environment providing one or more applications for content creation using one or more I/O devices of the IHS;
once the virtual environment has been launched, monitor user inputs to the I/O devices of the IHS and monitor imports to the virtual environment;
detect entry of content to an application of the virtual environment;
generate an originality score for the entered content based on the detected user inputs to the I/O devices of the IHS and further based on the monitored imports to the virtual environment; and
when the originality score indicates the entered content was human-generated, generate an attestation certificate for validation of the entered content as human-generated.

15. The IHS of claim 14, wherein the monitoring of imports to the virtual environment comprises monitoring activity of a clipboard of an operating system of the IHS.

16. The IHS of claim 14,, wherein the monitoring of imports to the virtual environment comprises monitoring file operations by the user of the IHS.

17. The IHS of claim 14, wherein execution of the instructions further causes the IHS to monitor Internet activity by the user, and wherein the originality score is further generated based on Internet activity by the user.

18. A computer-readable storage device having instructions stored thereon for attested content creation by an IHS (Information Handling System), wherein execution of the instructions by one or more processors of the first IHS causes the one or more processors to:
launch a virtual environment for attested content creation by a user of the IHS, the environment providing one or more applications for content creation using one or more I/O devices of the IHS;
once the virtual environment has been launched, monitor user inputs to the I/O devices of the IHS and monitor imports to the virtual environment;
detect entry of content to an application of the virtual environment;
generate an originality score for the entered content based on the detected user inputs to the I/O devices of the IHS and further based on the monitored imports to the virtual environment; and
when the originality score indicates the entered content was human-generated, generate an attestation certificate for validation of the entered content as human-generated.

19. The computer-readable storage device of claim 18, wherein the monitoring of imports to the virtual environment comprises monitoring activity of a clipboard of an operating system of the IHS.

20. The computer-readable storage device of claim 18, wherein the monitoring of imports to the virtual environment comprises monitoring file operations by the user of the IHS.
